(19) United States
(12) Patent Application Publication
(10) Pub. No.: US 2013/0076533 A1
(43) Pub. Date: Mar. 28, 2013

(54) DATA PROCESSOR FOR ONLINE BIOMETRIC MONITORING

(71) Applicant: WIRELESS MEDICAL LTD., YARKONA (IL)

(72) Inventor: DOV MORAN, KFAR SABA (IL)

(73) Assignee: WIRELESS MEDICAL LTD., YARKONA (IL)

(21) Appl. No.: 13/624,990

(22) Filed: Sep. 24, 2012

Related U.S. Application Data
(60) Provisional application No. 61/538,962, filed on Sep. 26, 2011.

(51) Int. Cl. G08C 17/02

(52) U.S. Cl. CPC G08C 17/02
USPC 340/870.02

(57) ABSTRACT

A biometric meter data processor including a modem, a file system including a data file, a touchscreen for presenting to a user, a biometric monitor, driver circuitry for enabling the biometric monitor to measure a biometric of a user wherein the biometric monitor is unable to measure the biometric of the user when it is not connected to a connector, coupled with the modem.

### CROSS-REFERENCE TO RELATED APPLICATIONS

This application claims priority benefit from U.S. Provisional Patent Application No. 61/538,962, filed Sep. 26, 2011, which is incorporated herein by reference in its entirety.

### FIELD AND BACKGROUND OF THE DISCLOSURE

The disclosure herein relates to the monitoring of biometric such as glucose levels and the like. In particular the disclosure relates to collecting biometrics and making them accessible online.

Home telemedicine has developed to the stage where patients at home can monitor their biometrics, such as their blood pressure, their glucose level and their body weight, and the results are transmitted to a remote health care professional. In this way, patients' health may be monitored regularly, without the need for the patients to come to a health care facility for routine checkups. Transmission of results is performed by a wired or wireless Internet connection in the home.

A limitation of home telemedicine, however, is the inability to conveniently measure biometrics and transmit the results when a user is outside of his home. For example, the user may be a child at school, or a patient on travel. Unless the user has access to a wired or wireless Internet connection, the user cannot transmit biometric results to his parent or to his physician.

Moreover, a communication device that the user may have on hand, such as his cell phone, is not able to cooperate with a biometric monitor, since the communication device is often configured as a USB slave, whereas the biometric monitor requires cooperation with a computer that is configured as a USB master.

There is thus a need to improve home telemedicine so as to enable users on-the-go to monitor their health metrics and transmit the results to their physicians or to their parents. The present disclosure addresses this need.

### SUMMARY OF THE INVENTION

Aspects of the present invention relate to a mobile phone that cooperates with a biometric monitor to measure a biometric of a user, to transmit the measurement to a remote computer, to analyze the measurements, and to presents results of the analysis to the user. As such, the biometric monitor may be used by a user at home, at work, in school, on travel, and practically anywhere in the world, and the results may be monitored remotely. Health care providers can user the present invention to monitor patients regardless of their whereabouts. Parents can use the present invention to monitor children at school or elsewhere outside of the home.

In general, the biometric monitor is a very simple device that has no display, and that is unable to measure a biometric unless it is connected to the mobile phone.

Embodiments of the present invention include a data processing device configured as a USB slave, to which a biometric monitor may be connected. When the biometric monitor is connected to the data processing device, the biometric monitor writes its measurements to a file system of the data processing device. The data processing device extracts the measurements, transmits the measurements to a remote computer, analyses the measurements, and presents results of the analysis to a user on a screen of the data processing device. The analysis results presented to the user include inter alia a history graph and health assessments. The data transmitted to the remote computer is available for review by a parent, a physician, or such other health care professional.

In accordance with an embodiment of the present invention, the biometric monitor indicates its activity status by writing one or more activity status codes to one or more status files in the file system of the data processing device, and writes its biometric measurements to one or more data files in the file system of the data processing device. When the biometric monitor is connected to the data processing device, the data processing device reads the activity status codes, and prompts the user to perform an appropriate action. Subsequently, upon performance of the user action, the biometric monitor performs its measurements and writes the measurements to the data files. The data processing device then extracts the biometric measurements from the data files.

There is thus provided in accordance with an embodiment of the present invention a data processor for a biometric meter, including a modem for wireless transmission of data, a file system, coupled with the modem, including at least one data file, a screen, coupled with the modem and with the file system, for presenting data stored in the at least one data file to a user, a connector, coupled with the modem, for connection with a biometric monitor, driver circuitry, coupled with the modem and with the connector, for enabling the biometric monitor to measure a biometric of a user and to write the measurement to at least one data file in the file system while the biometric monitor is connected to the connector, and wherein the biometric monitor is unable to measure the biometric of the user when it is not connected to the connector, processor circuitry, coupled with the modem, with the file system, with the screen and with the driver circuitry, (i) for extracting a measurement written to at least one of the data files by the biometric monitor, (ii) for instructing the modem to transmit the extracted measurement to a remote computer, (iii) for analyzing measurements in the at least one data file, and (iv) for displaying results of the analysis on the screen to the user.

There is additionally provided in accordance with an embodiment of the present invention a method for a data processor to process measurements made by a biometric monitor, including recognizing, by a data processor, a communication connection with a device, determining, by the data processor, that the connected device is a biometric monitor, including searching for a file with a designated name in a file system, enabling, by the data processor, the biometric monitor to measure a biometric of a user, monitoring, by the data processor, operation of the biometric monitor including periodically extracting at least one activity status code from at least one designated status file in the file system, extracting, by the data processor, a measurement recorded by the biometric monitor in at least one designated data file in the file system, transmitting, by the data processor, the extracted measurement to a remote computer, analyzing, by the data processor, measurements stored in the at least one designated data file in the file system, and displaying, by the data processor, results of the analysis on a screen for the user, wherein the biometric monitor is unable to measure the biometric of the user without the enabling by the data processor.

There is further provided in accordance with an embodiment of the present invention a biometric monitor, including measurement circuitry for measuring a biometric of a user, a connector for connection with a data processor, and driver circuitry, coupled with the measurement circuitry and with the connector, for enabling the biometric monitor to measure the biometric of the user and to write the measurement to a file in a file system of the data processor, wherein the biometric monitor is unable to measure the biometric of the user when it is not connected to the data processor.

The is yet further provided in accordance with an embodiment of the present invention a biometric monitoring system, including a biometric monitor, including measurement circuitry for measuring a biometric of a user, a first connector for connection with a data processor, and first driver circuitry, coupled with the measurement circuitry and with the first connector, for enabling the biometric monitor to write a measurement to at least one data file in a file system of the data processor while the data processor is connected to the first connector, and the data processing device, including a modem for wireless transmission of data, a file system, coupled with the modem, including at least one data file, a screen, coupled with the modem and with the file system, for presenting data stored in the at least one data file to the user, a second connector, coupled with the modem, for connection with the biometric monitor, second driver circuitry, coupled with the modem and with the second connector, for enabling the biometric monitor to measure the biometric of the user while the biometric monitor is connected to the second connector, wherein the biometric monitor is unable to measure the biometric of the user when it is not connected to the second connector, and processor circuitry, coupled with the modem, with the file system, with the screen and with the second driver circuitry, (i) for extracting a measurement written to at least one of the data files by the biometric monitor, (ii) for instructing the modem to transmit the extracted measurement to a remote computer, (iii) for analyzing measurements in the at least one data file, and (iv) for displaying results of the analysis on the screen to the user.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1A schematically represents an online biometric monitoring system incorporating a data processor of the disclosure;

FIG. 1B is a simplified block diagram of an example of a data processor for use with a glucose monitor; and

FIG. 2 is a simplified flowchart showing selected stages of a method for a data processor to process measurements made by a glucose monitor.

### DETAILED DESCRIPTION OF THE INVENTION

Aspects of the present disclosure relate to a data processing device that cooperates with a biometric monitor. The biometric monitor measures health signs such as blood pressure, glucose level and body weight. The biometric monitor measures a biometric of a user and writes the measurement to a data file in the data processing device's file system. The data processing device transmits the measurement to a remote computer, analyzes the measurements, and presents results of the analysis, including inter alia a history graph and health assessments, to the user.

Optionally, the biometric monitor and the data processing device may be incorporated into a common unit comprising biometric sensors, processors, a modem for connecting to a remote server, an input device and an output display. It is noted that a user interface such as a touch screen or the like, may serve both as input and output devices. Use of a touch screen may allow the screen to be larger without compromising the size of a separate input device such as a key pad. Furthermore, a touch screen input device may be easier to use for the untrained user as it may use easy to interpret icons rather than complicated text based instructions.

Alternatively, the biometric monitor and data processing device may be interdependent modules which rely one upon the other to perform all the required operations. For example, the biometric monitor may not itself have a display unit and may not able to measure the biometric of the user unless it is connected to the data processing device. The data processing device may enable the biometric monitor to operate. Accordingly, the biometric monitor may connect to the data processing device via a cable with a mini/micro USB plug, for example or use a wireless connection protocol such as WiFi, Bluetooth or the like.

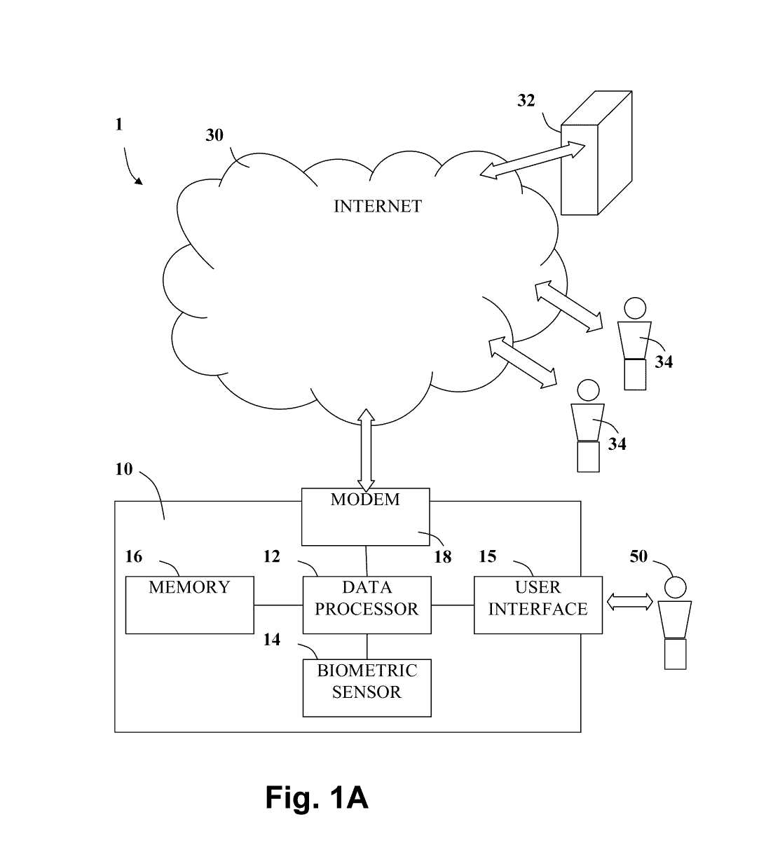

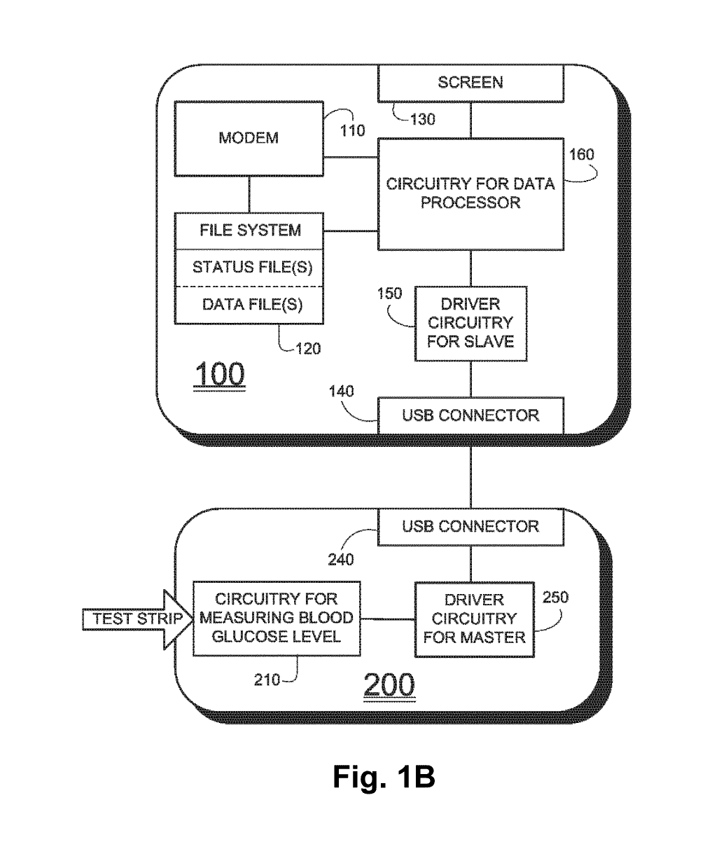

Reference is now made to FIG. 1A schematically representing an example of an online biometric monitoring system 1 which may be used to provide remote access to medical data. The online biometric monitoring system 1 includes a biometrical monitoring unit 10 and a remote server 32 in communication with the internet 30. The biometric monitoring unit 10 includes a data processor 12, a biometric sensor 14, a modem 16 and a user interface 15.

The biometric sensor 14, such as a pulse reader, blood pressure monitor, test strip reader or the like, may provide measurements of biometric parameters. The data processor may access these measurement as well as data stored in the memory 16 and additional data provided by a user 50 via a user interface. The user interface 15 such as a touch screen, display, keypad, pointing device or the like, may provide two way communication between the monitor 10 and the user via which information may be shared by a user 50 and the data processor 12.

It is particularly noted that the modem 18 may provide a communication channel between the monitor 10 and the internet 30 such that data may be uploaded to the remote server 32. It is particularly noted that remotely stored data may be accessed by remote carers 34 such as doctors, nurses, parents and the like who have access to the internet 30.

By way of example only, reference is made to FIG. 1B, which represents a simplified block diagram of a modular data processor and biometric monitor in accordance with one embodiment of the present disclosure. Shown in FIG. 1 is a data processing device 100 and a biometric monitor 200, such as a glucose monitor for example. In the modular system, the data processing device 100 may be a smart phone or a portable data assistance (PDA), with an application installed for cooperating with biometric monitor 200. Alternatively, in other embodiments, the data processing device may be integral to the biometric monitor itself. The biometric monitor 200 may be a glucose meter, a blood pressure reader or a body weight scale. Biometric monitor 200 may also be a biometric scanner, such as a camera, a fingerprint scanner, a palm scanner or a retinal scanner. For clarity of exposition, data processing device 100 and biometric monitor 200 are shown in FIG. 1 as a smart phone and a glucose monitor, respectively.

Data processing device 100 includes a modem 110 for wireless transmission of data, a file system 120 for storing one or more status files and one or more data files, a screen 130 for presentation of information to a user, a USB connector 140 for connecting data processing device 100 with biometric monitor 200, circuitry 150 for a USB slave, and circuitry 160 for a data processor. Circuitry 150 enables data processing device 100 to recognize connection of biometric monitor 200, and enables biometric monitor to write to file system 120.

The screen 130 may be used to provide a user interface for displaying instructions, presenting data or the like. In particular embodiments, a touchscreen may be used to further provide an input mechanism for providing user defined data to the data processor.

It is noted that where a modular system is used, the data processing device 100 may function as a USB slave, for peripheral connection to a host computer that functions as a USB master.

Biometric monitor 200 includes circuitry 210 for measuring blood glucose level, a USB connector 240 for connection with USB connector 140, and circuitry 250 for a USB master. Circuitry 250 enables biometric monitor to write its measurements to file system 120 of data processing device 100.

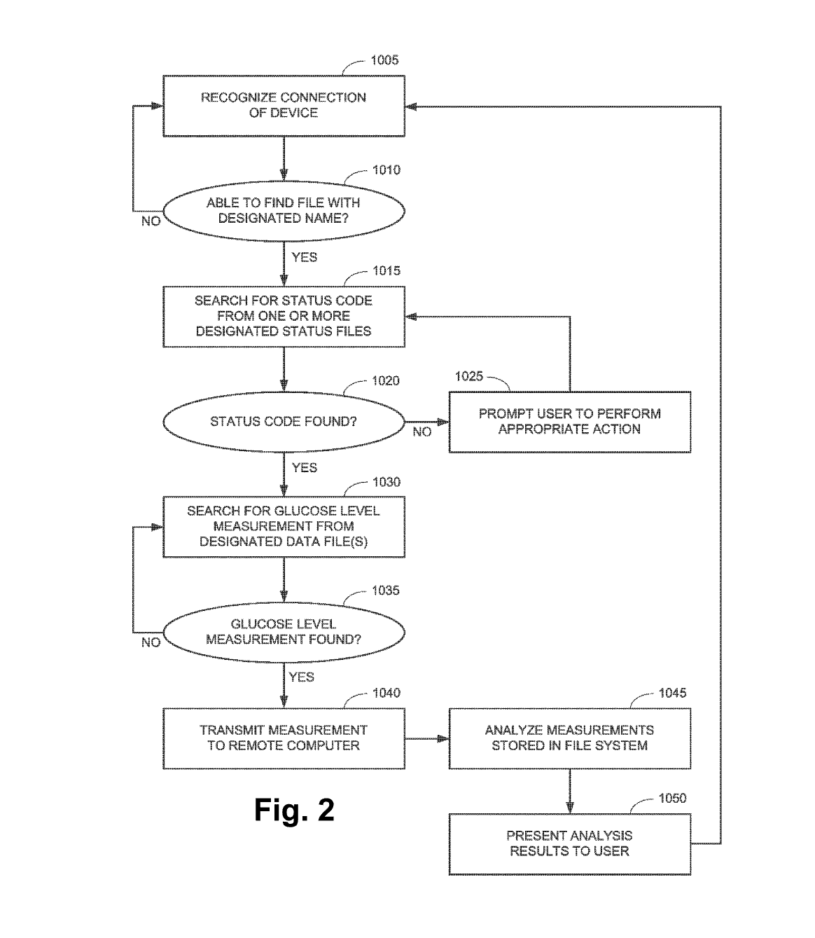

Reference is now made to FIG. 2, which a simplified flowchart of a method for a data processor to process measurements made by a modular glucose monitor, in accordance with an embodiment of the present disclosure. The method of FIG. 2 is implemented by a data processing device, such as data processing device 100 of FIG. 1B, to which a biometric monitor, such as biometric monitor 200 of FIG. 1B, is connected.

At step 1005 the data processing device recognizes that another device has been connected to it. If the other device is a biometric monitor, then it writes a file with a designated file name in the file system of the data processing device, in order to notify the data processing device that the biometric monitor is now connected. At step 1010 the data processing device searches for the file with the designated name in its file system. In addition to the designated file name, a designated folder path may be provided, for indicating where to locate the file with the designated file name. If the file being searched for is not found, then the method returns to step 1005. Otherwise, if the file with the designated file name is located, then this indicates that the connected device is a biometric monitor.

In accordance with an embodiment of the present disclosure, as biometric activities progress, the biometric monitor writes activity status codes or status texts to one or more designated status files in the file system of the data processing device. Examples of statuses that are coded with status codes include inter alia “waiting for test strip”, “test in process”, and “test complete”.

At step 1015, the data processing device searches for one or more status codes in the one or more designated status files. If, at step 1020, a given status code is not found, then at step 1025 the data processing device prompts the user to perform an appropriate action, and the method returns to step 1015. The data processing device may also provide the user with directions for performing the action. For example, if the biometric monitor is waiting for the user to insert his test strip, the data processing device may display a message such as “Glucose monitor connected. Please check your blood glucose level and insert your test strip into the monitor.” The prompt to the user may be a visual or audio prompt, and the directions may be visual or audio directions.

In accordance with an embodiment of the present disclosure, as each biometric measurement is made, the biometric monitor writes the measurement to one or more designated data files in the file system of the data processing device.

If, at step 1020, the given status code is found, then at step 1030 the data processing device searches for a recorded blood glucose level measurement in the one or more designated data files. If, at step 1035, the measurement is not found, then the method returns to step 1030.

Otherwise if, at step 1035, the measurement is found, then at step 1040 the measurement is transmitted to a remote computer, such as a computer at a remote care provider where the measurement is monitored by a physician or other care provider professional. Alternatively, the measurement may be monitored by a parent. Yet alternatively, the measurement may be monitored by a security service. The remote computer may be a web server, which enables a physician or parent to view the measurement with a web browser. In addition to transmission of measurements, the data processing device may transmit a message to the physician, health care professional or parent. At step 1045 the measurements are analyzed, and at step 1050 results of the analysis are presented to the user. The results may include history graphs and health assessments.

The present disclosure has broad application to a variety of monitors, in addition to biometric monitors, which may be connected via a communication device for data processing and transmission and presentation of results. For example, the present disclosure applies to many types of scanners including inter alia cameras, fingerprint scanners, palm scanners and retinal scanners. The scanner may be a simple low cost device without a display.

In the foregoing specification, the disclosure has been described with reference to specific exemplary embodiments thereof. It will, however, be evident that various modifications and changes may be made to the specific exemplary embodiments without departing from the broader spirit and scope of the disclosure as set forth in the appended claims. Accordingly, the specification and drawings are to be regarded in an illustrative rather than a restrictive sense.

The scope of the disclosed subject matter is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

What is claimed is:

1. A data processor for a biometric meter, comprising:
a modem for wireless transmission of data;
a file system, coupled with said modem, comprising at least one data file;
a screen, coupled with said modem and with said file system, for presenting data stored in said at least one data file to a user;
a connector, coupled with said modem, for connection with a biometric monitor;
driver circuitry, coupled with said modem and with said connector, for enabling the biometric monitor to measure a biometric of a user and to write the measurement to at least one data file in said file system while the biometric monitor is connected to said connector, and wherein the biometric monitor is unable to measure the biometric of the user when it is not connected to said connector;
processor circuitry, coupled with said modem, with said file system, with said screen and with said driver circuitry, (i) for extracting a measurement written to at least one of the data files by the biometric monitor, (ii) for instructing said modem to transmit the extracted measurement to a remote computer, (iii) for analyzing measurements in the at least one data file, and (iv) for displaying results of the analysis on said screen to the user.

2. The data processor of claim 1 wherein said file system further comprises at least one status file, wherein said driver circuitry enables the biometric monitor to write an activity status code to at least one status file in said file system while the biometric monitor is connected to said connector, and wherein said processor circuitry prompts the user to perform an appropriate action based on at least one activity status code stored in at least one status file.

3. The data processor of claim 1 wherein said processor circuitry prompts the user with a visual prompt.

4. The data processor of claim 1 wherein said processor circuitry prompts the user with an audio prompt.

5. The data processor of claim 1 wherein the biometric monitor is a member of the group consisting of a glucose meter, a blood pressure reader, and a body weight scale.

6. The data processor of claim 1 wherein the biometric monitor is a member of the group consisting of a camera, a fingerprint scanner, a palm scanner, and a retinal scanner.

7. A method for a data processor to process measurements made by a biometric monitor, comprising:
recognizing, by a data processor, a communication connection with a device;
determining, by the data processor, that the connected device is a biometric monitor, comprising searching for a file with a designated name in a file system;
enabling, by the data processor, the biometric monitor to measure a biometric of a user;
monitoring, by the data processor, operation of the biometric monitor comprising periodically extracting at least one activity status code from at least one designated status file in the file system;
extracting, by the data processor, a measurement recorded by the biometric monitor in at least one designated data file in the file system;
transmitting, by the data processor, the extracted measurement to a remote computer;
analyzing, by the data processor, measurements stored in the at least one designated data file in the file system; and
displaying, by the data processor, results of the analysis on a screen for the user, wherein the biometric monitor is unable to measure the biometric of the user without said enabling by the data processor.

8. The method of claim 7 wherein said monitoring comprises:
reading, by the data processor, at least one activity status code in the at least one designated status file; and
prompting, by the data processor, the user to take an appropriate action based on the at least one activity status code that was read.

9. The method of claim 7 wherein said processor circuitry prompts the user with a visual prompt.

10. The method of claim 7 wherein said processor circuitry prompts the user with an audio prompt.

11. The method of claim 7 wherein the biometric monitor is a member of the group consisting of a glucose meter, a blood pressure reader, and a body weight scale.

12. The method of claim 7 wherein the biometric monitor is a member of the group consisting of camera, a fingerprint scanner, a palm scanner, and a retinal scanner.

13. A biometric monitor, comprising:
measurement circuitry for measuring a biometric of a user;
a connector for connection with a data processor; and
driver circuitry, coupled with said measurement circuitry and with said connector, for enabling the biometric monitor to measure the biometric of the user and to write the measurement to a file in a file system of the data processor, wherein the biometric monitor is unable to measure the biometric of the user when it is not connected to the data processor.

14. The biometric monitor of claim 13 wherein the biometric measured by said measurement circuitry is a member of the group consisting of a blood glucose level, a blood pressure, and a body weight.

15. A biometric monitoring system, comprising:
a biometric monitor, comprising:
measurement circuitry for measuring a biometric of a user;
a first connector for connection with a data processor; and
first driver circuitry, coupled with said measurement circuitry and with said first connector, for enabling the biometric monitor to write a measurement to at least one data file in a file system of the data processor while the data processor is connected to said first connector; and
said data processing device, comprising:
a modem for wireless transmission of data;
a file system, coupled with said modem, comprising at least one data file;
a screen, coupled with said modem and with said file system, for presenting data stored in said at least one data file to the user;
a second connector, coupled with said modem, for connection with said biometric monitor;
second driver circuitry, coupled with said modem and with said second connector, for enabling said biometric monitor to measure the biometric of the user while the biometric monitor is connected to said second connector, wherein said biometric monitor is unable to measure the biometric of the user when it is not connected to said second connector; and
processor circuitry, coupled with said modem, with said file system, with said screen and with said second driver circuitry, (i) for extracting a measurement written to at least one of the data files by said biometric monitor, (ii) for instructing said modem to transmit the extracted measurement to a remote computer, (iii) for analyzing measurements in the at least one data file, and (iv) for displaying results of the analysis on said screen to the user.
